(19) United States
(12) Patent Application Publication
(10) Pub. No.: US 2006/0292402 A1
(43) Pub. Date: Dec. 28, 2006

(54) MAGNETIC RECORDING MEDIUM

(75) Inventors: Tsutomu IDE, Tokyo (JP); Katsuhiko YAMAZAKI, Tokyo (JP); Tomoyuki KOTAKI, Tokyo (JP)

Correspondence Address: GREENBLUM & BERNSTEIN, P.L.C., 1950 ROLAND CLARKE PLACE, RESTON, VA, 20191, US

(73) Assignee: TDK CORPORATION, Tokyo (JP)

(21) Appl. No.: 11/424,005

(22) Filed: Jun. 14, 2006

(30) Foreign Application Priority Data
Jun. 17, 2005 (JP) 2005-177081

(51) Int. Cl. G11B 5/716

(52) U.S. Cl. 428/840.5; 428/840.2

(57) ABSTRACT

A magnetic recording medium has at least a non-magnetic layer and a magnetic layer formed in that order on one surface of a non-magnetic support. The non-magnetic layer is formed using a non-magnetic coating composition including a (meth)acryloyl group in a range of 11 mmol to 30 mmol, inclusive relative to 100 parts by weight of non-magnetic powder.

### BACKGROUND OF THE INVENTION

1. Field of the Invention

The present invention relates to a magnetic recording medium where a non-magnetic layer and a magnetic layer are formed in the mentioned order on a non-magnetic support.

2. Description of the Related Art

As one example of this type of magnetic recording medium, a magnetic recording medium (magnetic tape) disclosed by Japanese Laid-Open Patent Publication No. 2004-227705 is known. According to this magnetic recording medium, it is possible to make a non-magnetic layer (primer layer) durable and bond favorably to a non-magnetic support by using an electron beam-curable resin including an electron beam-sensitive double bond (for example, an acrylic double bond) as a binder in the non-magnetic layer.

### SUMMARY OF THE INVENTION

This type of magnetic recording medium needs to have a smooth surface (i.e., the surface of the magnetic layer) and to favorably clean a magnetic head (such as an MR head). In particular, there has been demand in recent years for a magnetic recording medium to clean a magnetic head optimally. However, with the conventional magnetic recording medium described above, it is difficult to optimize the cleaning performance while keeping the surface smooth.

By conducting detailed research into the above problem, the present inventors found that by forming the non-magnetic layer using an electron beam-curable resin including more acrylic double bonds than the electron beam-curable resin in normal conventional use, it is possible to realize a magnetic recording medium with optimized cleaning performance for a magnetic head (such as an MR head) while keeping the surface (i.e., the surface of the magnetic layer) smooth.

The present invention was conceived to solve the problem described above and it is a principal object of the present invention to provide a magnetic recording medium that has a smooth surface and optimal cleaning performance for a magnetic head.

To achieve the stated object, on a magnetic recording medium according to the present invention, at least a non-magnetic layer and a magnetic layer are formed in the mentioned order on one surface of a non-magnetic support, wherein the non-magnetic layer is formed using a non-magnetic coating composition including a (meth)acryloyl group in a range of 11 mmol to 30 mmol, inclusive relative to 100 parts by weight of non-magnetic powder. Note that the magnetic recording medium according to the present invention is not limited to a magnetic recording medium where only a non-magnetic layer and a magnetic layer are laminated on a non-magnetic support, and a magnetic recording medium where various functional layers are formed between the non-magnetic support and the non-magnetic layer, a magnetic recording medium where various functional layers are formed between the non-magnetic layer and the magnetic layer, and a magnetic recording medium where various functional layers are formed on the magnetic layer are included.

According to the above magnetic recording medium, by forming the non-magnetic layer using a non-magnetic coating composition including a (meth)acryloyl group in a range of 11 mmol to 30 mmol, inclusive relative to 100 parts by weight of non-magnetic powder, the non-magnetic layer can be hardened to a suitable hardness by electron beam irradiation. This means that after forming the magnetic layer on the nonmagnetic layer by a so-called “wet on dry” coating method, it is possible to keep the amount by which a magnetic head is abraded by the magnetic medium in a set range while keeping the center line average roughness Ra of the magnetic layer during the calendering process in a set range.

The non-magnetic coating composition may include the (meth)acryloyl group in a range of 15 mmol to 26 mmol, inclusive. By doing so, it is possible to keep the amount by which a magnetic head is abraded by the magnetic medium in a more preferable range within the set range while keeping the center line average roughness Ra of the magnetic layer during the calendering process in a set range.

It should be noted that the disclosure of the present invention relates to a content of Japanese Patent Application 2005-177081 that was filed on 17 Jun. 2005 and the entire content of which is herein incorporated by reference.

### BRIEF DESCRIPTION OF THE DRAWINGS

These and other objects and features of the present invention will be explained in more detail below with reference to the attached drawings, wherein:

FIG. 1 is a cross-sectional view of a magnetic tape that is one example of a magnetic recording medium according to the present invention; and

FIG. 2 is a measurement results table showing the measurement results of the center line average roughness of surfaces of the non-magnetic layer and the magnetic layer and the sendust abrasion for a number of examples and comparative examples.

### DESCRIPTION OF THE PREFERRED EMBODIMENTS

Preferred embodiments of a magnetic recording medium according to the present invention will now be described with reference to the attached drawings.

First, the construction of a magnetic tape 1 that is one example of a magnetic recording medium according to the present invention will be described with reference to the drawings.

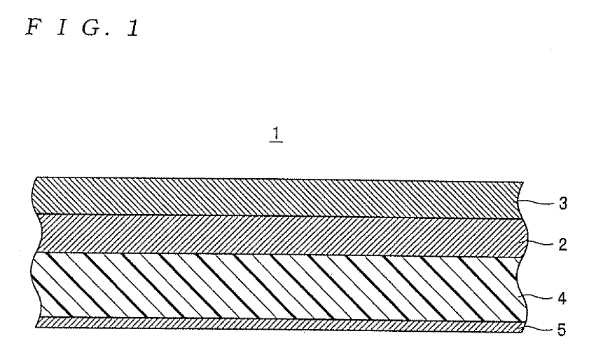

A magnetic tape 1 shown in FIG. 1 has a non-magnetic layer 2 and a magnetic layer 3 formed in the mentioned order on one surface (the upper surface in FIG. 1) of a base film 4 (a “non-magnetic support” for the present invention), and is constructed so that various types of data can be recorded and reproduced by a recording/reproducing apparatus, not shown. Also, to improve the running characteristics of the tape, to prevent damage (abrasion) to the base film 4 and to prevent the magnetic tape 1 from becoming electrically charged, a back coat layer 5 is formed on the other surface (the lower surface in FIG. 1) of the base film 4. Note that in FIG. 1, for ease of understanding the present invention, the thickness of the magnetic tape 1 has been exaggerated and the ratio of thicknesses of the various layers has been shown differently to the actual ratio. To improve the bonding of the non-magnetic layer 2 to the base film 4, a primer layer (adhesion enhancing layer) may be provided between the base film 4 and the non-magnetic layer 2. Note that other functional layers may be provided between the base film 4, the non-magnetic layer 2, and the magnetic layer 3.

Base Film

There are no particular limitations on the material used as the base film 4 and the material can be selected from various types of flexible materials and various types of rigid materials according to the intended use, with the base film 4 being formed with a predetermined form, such as a tape-like form, and dimensions in accordance with various standards. As examples of flexible materials, a resin material such as polyester (for example, polyethylene terephthalate (PET) or polyethylene naphthalate (PEN)), polyolefin (for example, polypropylene), polyamide, polyimide, and polycarbonate can be used. In this case, after the various layers have been formed, the base film 4 and the layers are cut out into predetermined widths that are set for magnetic recording media. To make it possible to increase the recording capacity, the thickness of the base film 4 should preferably be set in a range of 3.0 μm to 15.0 μm, inclusive. Note that although the base film 4 is formed in a long belt-like shape (a tape) in the present embodiment, the base film 4 may be formed in a variety of shapes such as a sheet, a card, or a disk.

Non-Magnetic Layer

The non-magnetic layer 2 is formed using a non-magnetic coating composition that includes at least non-magnetic powder and an electron beam-curing binder or alternatively a non-magnetic coating composition including an electron beam-curing binder and an electron beam-curing polyfunctional monomer.

As the non-magnetic powder, it is possible to use carbon black or a variety of non-carbon black non-magnetic inorganic powders. As the carbon black, it is possible to use furnace black used in rubber products, thermal black used in rubber products, black used in printing, acetylene black, or the like. Here, the BET specific surface area should preferably be within a range of 5 m²/g to 600 m²/g, inclusive, the DBP oil absorption within a range of 30 ml/100 g to 400 ml/100 g, inclusive, and the average particle diameter in a range of 10 nm to 100 μm, inclusive. The carbon black that can be used can be decided by referring to the “Carbon Black Handbook” (produced by the Carbon Black Association). The proportion of the carbon black in the non-magnetic layer 2 may be in a range of 5% by weight to 30% by weight inclusive, and preferably in a range of 10% by weight to 25% by weight inclusive.

As the non-carbon black non-magnetic inorganic powder, it is possible to use one of acicular non-magnetic iron oxide (such as α-Fe₂O₃ or α-FeOOH), calcium carbonate (CaCO₃), titanium oxide (TiO₂), barium sulfate (BaSO₄) and α-alumina (α-Al₂O₃), or a mixture of such non-magnetic inorganic powders. Also, the mixed proportions of the carbon black and the non-carbon black non-magnetic inorganic powder may be set so that the weight ratio (carbon black: non-magnetic inorganic powder) is in a range of 100:0 to 5:95, inclusive, and preferably in a range of 40:60 to 5:95, inclusive. Here, if the proportion of carbon black is below 5% by weight, there are problems such as the non-magnetic layer 2 having high surface electrical resistance and the light transmission becoming high.

According to the present invention, an electron beam-curing binder is used as the binder of the non-magnetic layer 2. Here, as described below, a combination of a vinyl chloride copolymer and polyurethane resin should preferably be used.

As the vinyl chloride copolymer, a copolymer including 50% by weight to 95% by weight inclusive of vinyl chloride may be used, with a copolymer including 55% by weight to 90% by weight inclusive of vinyl chloride being more preferable. The average degree of polymerization is preferably in a range of 100 to 500, inclusive. In particular, a copolymer of vinyl chloride and a monomer including an epoxy (glycidyl) group should preferably be used as the vinyl chloride copolymer. The vinyl chloride copolymer can be altered so as to become curable by an electron beam by introducing a (meth)acrylic double bond or the like using a well-known method.

The polyurethane resin that can be used together with the vinyl chloride copolymer described above is a general name for a resin produced by a reaction between a hydroxy group-containing resin, such as polyester polyol and/or polyether polyol, and a polyisocyanate-containing compound. Such polyurethane resin has a number-average molecular weight of around 5,000 to 200,000, inclusive and a Q value (weight-average molecular weight/number-average molecular weight) of around 1.5 to 4. The polyurethane resin may be altered to an electron beam-sensitive resin by introducing a (meth)acryloyl group using a well-known method.

Aside from the vinyl chloride copolymer and polyurethane resin, various well-known resins may be included in a range of 20% by weight or less of all of the binder included in the non-magnetic layer 2.

In the present invention, to improve the crosslinking of the electron beam-curing binder, it is possible to use an electron beam-curable polyfunctional monomer as a crosslinking agent, and in such case, polyfunctional (meth)acrylate should preferably be used.

There are no particular limitations on the polyfunctional (meth)acrylic monomer used, and ethylene glycol di(meth)acrylate, diethylene glycol di(meth)acrylate, polyethylene glycol di(meth)acrylate, 1,6-hexane glycol di(meth)acrylate, pentaerythritol tetra(meth)acrylate, trimethylol propane tri(meth)acrylate, and trimethylol propane di(meth)acrylate can be given as examples.

Also, the following diacrylate adducts can be preferably used as the polyfunctional (meth)acrylic monomer.

A diacrylate adduct (IPDI-2HPA) produced by adding hydroxypropyl acrylate (HPA) via the hydroxyl group to the two isocyanate groups of isophorone diisocyanate (IPDI)

A diacrylate adduct (IPDI-2HEA) produced by adding hydroxyethyl acrylate (HEA) via the hydroxyl group to the two isocyanate groups of isophorone diisocyanate (IPDI)

A diacrylate adduct (TDI-2HPA) produced by adding hydroxypropyl acrylate (HPA) via the hydroxyl group to the two isocyanate groups of tolylene 2,4-diisocyanate (TDI)

The included amount of electron beam-curing binder in the non-magnetic layer 2 should preferably be in a range of 10 parts by weight to 100 parts by weight, inclusive and more preferably in a range of 12 parts by weight to 30 parts by weight, inclusive relative to 100 parts by weight of the total of the carbon black and the non-carbon black non-magnetic powder in the non-magnetic layer 2. If the included amount of electron beam-curing binder is too small, the proportion of the electron beam-curing binder in the non-magnetic layer 2 falls and sufficient coating strength is not achieved. On the other hand, if the included amount of electron beam-curing binder is too large, in the case of a tape-shaped medium such as a magnetic tape, the tape will be susceptible to becoming prominently bent in the width direction, resulting in a tendency for poor contact with the magnetic head.

Here, it is possible to include a lubricant in the non-magnetic layer 2 as necessary. More specifically, as the lubricant, it is possible to use one or a mixture of two or more well-known substances such as a fatty acid such as stearic acid and myristic acid, a fatty acid ester such as butyl stearate and butyl palmitate, or a sugar, regardless of whether such substances are saturated or unsaturated. It is also preferable to use a mixture of two or more fatty acids with different melting points or a mixture of two or more fatty acid esters with different melting points. This is because it is necessary to constantly supply a lubricant suited to all of the temperature environments in which the magnetic tape 1 will be used to the surface of the magnetic tape 1. The amount of lubricant included in the non-magnetic layer 2 can be adjusted as appropriate according to use, but should preferably be in a range of 1% by weight to 20% by weight inclusive relative to the total weight of the carbon black and the non-carbon black non-magnetic inorganic powder in the non-magnetic layer 2.

The non-magnetic coating composition for forming the non-magnetic layer 2 can be prepared using a well-known method where an organic solvent is added to the various substances described above and processes such as mixing, agitating, kneading, and dispersing are carried out. There are no particular limitations on the organic solvent used, and it is possible to select and use one or a mixture of two or more solvents such as ketone solvents (for example, methyl ethyl ketone (MEK), methyl isobutyl ketone, and cyclohexanone) and aromatic solvents (for example, toluene). The added amount of organic solvent can be set in a range of 100 parts by weight to 900 parts by weight inclusive relative to 100 parts weight that is the total of the solid contents (carbon black, the non-carbon black non-magnetic inorganic powder, and the like), the electron beam-curing binder, the dispersant, and the crosslinking agent (polyfunctional monomer).

The non-magnetic coating composition should be adjusted to include the (meth)acryloyl group in a range of 11 mmol to 30 mmol, inclusive and preferably in a range of 15 mmol to 26 mmol, inclusive relative to 100 parts by weight of the non-magnetic powder (the carbon black and the non-carbon black non-magnetic inorganic powder). Here, as the included amount of (meth)acryloyl group increases relative to the non-magnetic powder in the non-magnetic coating composition, the hardness of the non-magnetic layer 2 formed by the non-magnetic coating composition increases. As the hardness of the non-magnetic layer 2 increases, the surface characteristics of the non-magnetic layer 2 following the calendering process improve. As described later, the center line average roughness Ra of the surface of the magnetic layer 3 formed on the non-magnetic layer 2 falls as the surface characteristics of the non-magnetic layer 2 improve. For this reason, in the non-magnetic coating composition, the included amount of (meth)acryloyl group should preferably be at least 11 mmol and preferably at least 15 mmol relative to the non-magnetic powder in the non-magnetic coating composition so that the formed non-magnetic layer 2 has at least a predetermined hardness which results in the center line average roughness Ra of the surface of the magnetic layer 3 being a predetermined value or below. On the other hand, if the non-magnetic layer 2 is too hard, when the calendering process is carried out on the magnetic layer 3, the penetration into the non-magnetic layer 2 of the abrasive included in the magnetic layer 3 is too shallow and therefore the amount by which the abrasive protrudes from the magnetic layer 3 increases, resulting in the magnetic tape 1 causing excessive abrasion of the magnetic head. For this reason, in the non-magnetic coating composition, the included amount of (meth)acryloyl group should be 30 mmol or below and preferably 26 mmol or below relative to the non-magnetic powder in the non-magnetic coating composition so that the formed non-magnetic layer 2 is not excessively hard, the abrasive included in the magnetic layer 3 suitably penetrates the non-magnetic layer 2 after the calendering process is carried out on the magnetic layer 3 so that the amount by which the abrasive protrudes from the magnetic layer 3 is suitable, and therefore the abrasion of the magnetic head by the magnetic tape 1 does not exceed an optimal range.

The non-magnetic layer 2 is normally formed with a thickness in a range of 0.3 μm to 2.5 μm, inclusive and preferably in a range of 0.3 μm to 2.3 μm. Here, in a state where the thickness of the non-magnetic layer 2 is below 0.3 μm, the non-magnetic layer 2 is susceptible to being affected by the surface roughness of the base film 4, resulting in deterioration in the smoothness of the surface of the non-magnetic layer 2 and in turn a tendency for deterioration in the smoothness of the surface of the magnetic layer 3. As a result, the electromagnetic conversion characteristics worsen and it becomes difficult to record data properly. Also, since the light transmission increases, it becomes difficult to detect the end of the magnetic tape 1 by detecting a change in light transmission. On the other hand, even if the non-magnetic layer 2 is formed with a thickness of over 2.5 μm, there will be no great improvement in the recording characteristics of the magnetic tape 1 and conversely it becomes difficult to form the non-magnetic layer 2 with a uniform thickness. In addition, since a large amount of non-magnetic coating composition will be used to form the non-magnetic layer 2, there is a risk of an increase in manufacturing cost.

Magnetic Layer

The magnetic layer 3 includes at least a ferromagnetic powder and a binder. As the ferromagnetic powder, metal magnetic powder or hexagonal plate-shaped fine powder should preferably be used. For the metal magnetic powder, the coercitivity Hc should preferably be in a range of 118.5 kA/m to 237 kA/m (1500 Oe to 3000 Oe), inclusive, the saturation magnetization as in a range of 90 Am²/kg to 160 Am²/kg (emu/g), inclusive, the average major axis length (the average major axis diameter) in a range of 0.02 μm to 0.1 μm, inclusive, the average minor axis length (the average minor axis diameter) in a range of 5 nm to 20 nm, inclusive, and the aspect ratio in a range of 1.2 to 20 inclusive. The coercitivity Hc of the magnetic tape 1 fabricated using the metal magnetic powder should preferably be in a range of 118.5 kA/m to 237 kA/m (1500 Oe to 3000 Oe), inclusive. For the hexagonal plate-shaped fine powder, the coercitivity Hc should preferably be in a range of 791 kA/m to 237 kA/m (1000 Oe to 3000 Oe), inclusive, the saturation magnetization as in a range of 50 Am²/kg to 70 Am²/kg (emu/g), inclusive, the average plate particle diameter in a range of 30 nm to 80 nm, inclusive, and the plate ratio in a range of 3 to 7, inclusive. The coercitivity Hc of the magnetic tape 1 fabricated using the hexagonal plate-shaped fine powder should preferably be in a range of 94.8 kA/m to 238.7 kA/m (1200 Oe to 3000 Oe) inclusive.

Here, the average major axis length of the ferromagnetic powder can be found by separating and extracting the ferromagnetic powder from a tape fragment of the magnetic tape 1 and then measuring the major axis length of the ferromagnetic powder from a photograph taken by a transmission electron microscope (TEM). One example of this procedure is given below.

(1) The back coat layer 5 is peeled off and removed from the tape fragment using a solvent.

(2) The tape fragment sample where the non-magnetic layer 2 and the magnetic layer 3 remain on the base film 4 is soaked in a 5% aqueous solution of NaOH, and simultaneously heated and agitated.

(3) The coating films that have fallen off the base film 4 are washed and dried.

(4) The dried coating films are ultrasonically treated in methyl ethyl ketone (MEK) and the magnetic powder is magnetically attracted to and collected by a magnetic stirrer.

(5) The magnetic powder is separated from the residue and dried.

(6) The ferromagnetic powder obtained in (4) and (5) is extracted using a special-purpose mesh to fabricate a TEM sample that is then photographed by a TEM.

(7) The major axis length of the ferromagnetic powder in the photograph is measured and averaged (the number of measurements n=100).

The ferromagnetic powder may constitute 70% by weight to 90% by weight of the magnetic layer 3 composition. If the included amount of ferromagnetic powder is too large, there will be a fall in the included amount of binder, making the magnetic layer 3 susceptible to deterioration in surface smoothness due to the calendering process. On the other hand, if the included amount of ferromagnetic powder is too little, a high reproduction output cannot be obtained.

There are no particular limitations on the binder of the magnetic layer 3, and it is possible to use a suitable combination of a thermoplastic resin, a thermosetting or reactive resin, a radiation (electron beam or UV ray) curing binder, and the like in accordance with the properties and processing conditions of the magnetic tape 1.

The included amount of binder used in the magnetic layer 3 is preferably set in a range of S parts by weight to 40 parts by weight, inclusive and more preferably in a range of 10 parts by weight to 30 parts by weight, inclusive relative to 100 parts by weight of the ferromagnetic powder. If the included amount of binder is too small, the strength of the magnetic layer 3 falls, making the magnetic tape 1 susceptible to a fall in running durability. On the other hand, if the included amount of binder is too large, there is a fall in the included amount of ferromagnetic powder, resulting in a tendency for a drop in the electromagnetic conversion characteristics.

Also, to improve the mechanical strength of the magnetic layer 3 and prevent clogging of the magnetic head, the magnetic layer 3 should preferably include an abrasive, such as α-alumina (Mohs hardness=9), with a Mohs hardness 6 or higher. This type of abrasive normally has an indeterminate form, and in addition to preventing clogging of the magnetic head, makes the magnetic layer 3 stronger.

The average particle diameter of the abrasive may be set in a range of 0.01 μm to 0.2 μm, inclusive, for example, and preferably in a range of 0.05 μm to 0.2 μm, inclusive. If the average particle diameter is too large, the amount by which the abrasive protrudes from the surface of the magnetic layer 3 becomes too large and there is a risk of a fall in the electromagnetic conversion characteristics, an increase in drop outs, an increase in abrasion of the magnetic head, and the like. On the other hand, if the average particle diameter is too small, the amount by which the abrasive protrudes from the surface of the magnetic layer 3 becomes too small and the effect of preventing clogging of the magnetic head becomes insufficient.

The average particle diameter of the abrasive is normally measured using a TEM. The included amount of abrasive is set in a range of 3 parts by weight to 25 parts by weight, inclusive and preferably in a range of 5 parts by weight to 20 parts by weight, inclusive relative to 100 parts by weight of the ferromagnetic powder. In addition, a dispersant such as a surfactant, a lubricant such as a higher fatty acid, a fatty acid ester, and silicon oil, or other additives should be added to the magnetic layer 3 as necessary.

The magnetic coating composition for forming the magnetic layer 3 is prepared according to a well-known method by adding an organic solvent to the substances described above and carrying out processes such as mixing, agitating, kneading, and dispersing. There are no particular limitations on the organic solvent used, and it is possible to use the same substances used for the non-magnetic layer 2.

The magnetic layer 3 is normally formed with a thickness in a range of 0.03 μm to 0.30 μm, inclusive, and preferably in a range of 0.05 μm to 0.25 μm, inclusive. The thickness of the magnetic layer 3 needs to be set in the ranges described above since the self-demagnetization loss and thickness loss become large if the magnetic layer 3 is too thick.

The center line average roughness Ra of the surface of the magnetic layer 3 should preferably be set in a range of 1.0 nm to 4.0 nm inclusive and more preferably in a range of 1.0 nm to 3.5 nm inclusive. If the center line average roughness Ra is below 1.0 nm, the surface of the magnetic layer 3 is too smooth, causing deterioration in the running stability and making the magnetic tape 1 susceptible to problems during running. On the other hand, if the center line average roughness Ra exceeds 4.0 nm, the surface of the magnetic layer 3 becomes rough, and for a reproduction system that uses an MR head, the electromagnetic conversion characteristics such as a reproduction output tend to deteriorate.

Back Coat Layer

The back coat layer 5 is provided as necessary to improve the running stability and to prevent the magnetic layer 3 from becoming electrically charged. Although there are no particular limitations on the structure or composition, as one example, it is possible to form the back coat layer 5 so as to include carbon black, non-carbon black non-magnetic inorganic powder, and a binder. Here, the back coat layer 5 should preferably include 30% by weight to 80% by weight of carbon black. As the non-carbon black non-magnetic inorganic powder, it is possible to use acicular non-magnetic iron oxide (such as α-Fe₂O₃ or α-FeOOH), CaCO₃, TiO₂, BaSO₄, α-Al₂O₃, or the like, and by doing so, it is possible to control the mechanical strength of the back coat layer S to a desired value.

The coating composition (back coat layer coating composition) for forming the back coat layer 5 is prepared according to a well-known method by adding an organic solvent to the substances described above and carrying out processes such as mixing, agitating, kneading, and dispersing. There are no particular limitations on the organic solvent used, and it is possible to use the same substances used for the non-magnetic layer 2.

The back coat layer 5 is formed with a thickness (after the calendering process) of 1.0 μm or below, and preferably in a range of 0.1 μm to 1.0 μm, inclusive, and more preferably in a range of 0.2 μm to 0.8 μm, inclusive.

Manufacturing the Magnetic Tape 1

The magnetic tape 1 shown in FIG. 1 is manufactured using the non-magnetic coating composition, the magnetic coating composition, and the back coat layer coating composition prepared as described above by forming the non-magnetic layer 2, the magnetic layer 3, and the back coat layer 5 on the base film 4 by carrying out processes such as coating, drying, calendering, and hardening.

The non-magnetic layer 2 and the magnetic layer 3 are formed using a so-called “wet on dry” coating method. More specifically, first the non-magnetic coating composition is applied on one surface of the base film 4, the coating composition is dried, and then a calendering process is carried out as necessary to form the non-magnetic layer 2 in a pre-hardened state. After this, the pre-hardened non-magnetic layer 2 is subjected to 1.0 Mrad to 6.0 Mrad, inclusive of electron beam irradiation to harden the non-magnetic layer 2. Next, the magnetic coating composition is applied onto the hardened non-magnetic layer 2 and then orienting and drying processes are carried out to form the magnetic layer 3. Note that the back coat layer 5 may be formed at any time in the order of processes. That is, the back coat layer 5 can be formed before the non-magnetic layer 2 is formed, following the formation of the non-magnetic layer 2 but before the magnetic layer 3 is formed, or after the magnetic layer 3 has been formed. Also, as one example, a calendering process may be carried out after both the magnetic layer 3 and the back coat layer 5 have been dried.

The amount of electron beam irradiation used to harden the non-magnetic layer 2 can be selected from a range of 1.0 Mrad to 6.0 Mrad, inclusive. If the amount of irradiation is below 1.0 Mrad, the non-magnetic layer 2 is insufficiently hardened, which adversely affects the smoothness of the surface of the magnetic layer 3. On the other hand, if the amount of irradiation exceeds 6.0 Mrad, a long irradiation time is required in accordance with the amount of irradiation, which is not desirable from a productivity viewpoint for the magnetic tape 1. For this reason, the amount of irradiation should preferably be set in a range that omits the lower and upper limits of the range described above, that is, a range of 2.0 Mrad to 4.5 Mrad, inclusive.

With the magnetic tape 1 according to the present invention, the non-magnetic layer 2 and the magnetic layer 3 are formed by a wet on dry coating method. Accordingly, since the magnetic coating composition for the magnetic layer 3 is applied on the non-magnetic layer 2 that has been hardened by electron beam irradiation, there is no disorder in the interface between the non-magnetic layer 2 and the magnetic layer 3. This means that a magnetic layer 3 with superior surface smoothness is obtained, which improves the electromagnetic conversion characteristics of the magnetic tape 1. It is also preferable for a calendering process to be carried out on the non-magnetic layer 2 before the magnetic coating composition for the magnetic layer 3 is applied. By doing so, it is possible to produce favorable surface characteristics for the non-magnetic layer 2, which makes it possible to form the magnetic layer 3 with superior surface smoothness and thereby to significantly improve the electromagnetic conversion characteristics. Regarding the surface characteristics of the non-magnetic layer 2, when the magnetic coating composition for the magnetic layer 3 is applied, for example, the center line average roughness Ra of the surface of the non-magnetic layer 2 should preferably be in a range of 1.5 nm to 4.5 nm, inclusive and more preferably in a range of 2.0 nm to 4.0 nm, inclusive. If the center line average roughness Ra exceeds 4.5 nm, the roughness of the non-magnetic layer 2 causes the magnetic layer 3 to become too rough. On the other hand, there is no particular need to make the center line average roughness Ra below 1.5 nm.

As the method of applying the non-magnetic coating composition, the magnetic coating composition, and the back coat coating composition, a variety of well-known application methods such as gravure coating, reverse roll coating, die nozzle coating, and bar coating can be used.

In this way, according to the magnetic tape 1, by forming the non-magnetic layer 2 using a non-magnetic coating composition including (meth)acryloyl group in a range of 11 mmol to 30 mmol, inclusive relative to 100 parts by weight of the non-magnetic powder, it is possible to harden the non-magnetic layer 2 to a suitable hardness by electron beam irradiation. This means that after the magnetic layer 3 has been formed on the non-magnetic layer 2 by the so-called wet on dry coating method, it is possible to keep the abrasion amount of a magnetic head due to the magnetic tape 1 in a set range while keeping the center line average roughness Ra of the magnetic layer 3 during the calendering process in a set range. In addition, by forming the non-magnetic layer 2 using a non-magnetic coating composition including (meth)acryloyl group in a range of 15 mmol to 26 mmol inclusive relative to 100 parts by weight of the non-magnetic powder, it is possible to keep the abrasion amount of a magnetic head due to the magnetic tape 1 in a more preferable range within the set range while keeping the center line average roughness Ra of the magnetic layer 3 during the calendering process in a set range.

### EXAMPLES

The magnetic tape 1 according to the present invention will now be described in detail with reference to examples.

Example Composition of Acrylic Monomer Resin (A1) Used in the Non-Magnetic Coating Composition

424 parts by weight of isophorone diisocyanate, 0.4 parts by weight of dibutyltin dilaurate, and 0.24 parts by weight of 2,6-tert-butyl-4-methyl phenol (BHT) were fed into a one-liter three-neck flask. While controlling the temperature to 60° C., 372 parts by weight of 2-hydroxypropyl acrylate were dripped. After dripping was completed, agitating was carried out for two hours at 60° C. and then the content of the flask was removed, thereby producing an IPDI-EPA adduct. Next, 1470 parts by weight of MEK solution was adjusted to a water content of 0.2% as a solvent, 3.97 parts by weight of dibutyltin dilaurate, and 0.35 parts by weight of an aluminum salt of N-nitrosophenyl hydroxylamine were fed, agitating was carried out for three hours at 70° C., and then 273 parts by weight of the IPDI-HPA adduct obtained above were introduced. After agitating for fifteen hours at 70° C., it was confirmed from an IR spectrum that the characteristic absorption (2270 cm⁻¹) of isocyanate group had disappeared, and after this, 0.35 parts by weight of an aluminum salt of N-nitrosophenyl hydroxylamine and 296 parts by weight of MEK were introduced, the mixture was mixed by agitation, and then the content of the flask was removed, thereby producing the resin (A1).

### Example 1

Preparation of the Non-Magnetic Coating Composition
Non-Magnetic Powder (Pigment)

| | |
|---|---|
| Acicular α-FeOOH | 80.0 parts by weight (average |
| | major axis length: 0.1 μm, crystallite diameter: 12 nm) |

Non-Magnetic Powder

| | |
|---|---|
| Carbon Black | 20.0 parts by weight (Product |
| | Name: “#950B” made by Mitsubishi Chemical Corp., |
| | average particle diameter: 17 nm, BET specific surface |
| | area: 250 m²/g, DBP oil absorption: 70 ml/100 g, pH: 8) |

Electron Beam-Curing Binder

| | |
|---|---|
| Electron Beam-Curable | 14.0 parts by weight (included amount of |
| Vinyl Chloride Resin (R1) | (meth)acryloyl group: 0.31 mmol/parts by weight, a |
| | copolymer of vinyl chloride and an epoxy-containing |
| | monomer, average degree of polymerization: 310) |

Electron Beam-Curing Binder

| | |
|---|---|
| Electron Beam-Curable | 8.0 parts by weight (included amount of |
| Polyurethane Resin (R2) | (meth)acryloyl group: 0.87 mmol/parts by weight, |
| | hydroxy-containing acrylic compound - a phosphonate |
| | group-containing phosphorus compound - hydroxy- |
| | containing polyester polyol, average molecular weight: |
| | 13,000) |
| Acrylic Monomer Resin (A1) | 0.0 parts by weight |
| | included amount of (meth)acryloyl group: 2.74 mmol/ |
| | parts by weight) |

Dispersant

| | |
|---|---|
| High molecular weight | 3.0 parts by weight (Product name: “DA-7500” made |
| polyester acid amide amine salt | by Kusumoto Chemicals, Ltd.) |

Abrasive

| | |
|---|---|
| α-alumina | 5.0 parts by weight (Product name |
| | “HIT60A” made by Sumitomo Chemical Co. Ltd., average |
| | particle diameter: 0.18 μm) |

NV (solid concentration) = 33%
(percentage by mass))

Solvent Proportions

MEK/toluene/cyclohexanone =
2/2/1 (ratio by mass)

After the materials described above had been kneaded by a kneader, the mixture was dispersed using a horizontal pin mill filled with 0.8 mm zirconia beads to a fill ratio of 80% (a void ratio of 50 vol %). After this, the lubricants described below

Lubricant

| | |
|---|---|
| Fatty Acid | 0.5 parts by weight |
| (Product name: “NAA180” | |
| made by NOF Corporation) | |
| Fatty Acid Amide | 0.5 parts by weight |
| (Product name: “Fatty Acid Amide S” | |
| made by Kao Corporation) | |
| Fatty Acid Ester | 1.5 parts by weight |
| (Product name: “NIKKOLBS” | |
| made by Nikko Chemicals Co., Ltd.) | |

were added, and the mixture was diluted to achieve an NV (solid concentration)=25% (percentage by mass) and solvent proportions of MEK/toluene/cyclohexane=2/2/1 (ratio by mass), and then dispersed. After this, by passing the obtained material through a filter with an absolute filtering accuracy of 3.0 μm, the non-magnetic coating composition for the present invention was fabricated.

Preparation of the Back Coat Layer Coating
Material

| | | |
|---|---|---|
| Carbon Black | 75 | parts by weight |
| (Product name: “BP-800” made by Cabot | | |
| Corporation, average particle diameter 17 nm, | | |
| BET specific surface area 210 m²/g) | | |
| Carbon Black | 10 | parts by weight |
| (Product name: “BP-130” made by Cabot | | |
| Corporation, average particle diameter 75 nm, | | |
| DBP oil absorption 69 ml/100 g, BET specific | | |
| surface area 25 m²/g) | | |
| Barium Sulfate | 15 | parts by weight |
| (Product name: “Barifine BF-20” made by Sakai | | |
| Chemical Industry Co., LTD., average particle | | |
| diameter 30 nm) | | |
| Nitrocellulose | 80 | parts by weight |
| (Product name: “BTH 1/2” made by Asahi Kasei | | |
| Corporation) | | |
| Polyurethane Resin | 40 | parts by weight |
| (Product name: “UR-8300” made by Toyobo Co., | | |
| Ltd., containing sodium sulfonate) | | |
| MEK | 150 | parts by weight |
| Toluene | 150 | parts by weight |
| Cyclo- | 80 | parts by weight |
| hexanone | | |

After sufficiently kneading the composition described above using a kneader, dispersing was carried out for five hours using a sand grind mill. After this, the materials listed below were introduced and dispersing was carried out using a sand grind mill for one hour.

| | |
|---|---|
| MEK | 400 parts by weight |
| Toluene | 400 parts by weight |
| Cyclohexanone | 200 parts by weight |

20 parts by weight of a thermal hardener (“Colonate L” made by Nippon Polyurethane Industry Co., Ltd.) were added and mixed into mixed solution obtained as described above, and by passing the composition through a filter with an absolute filtering accuracy of 1.0 μm, the back coat layer coating composition was fabricated.

Preparation of the Magnetic Coating Composition
Ferromagnetic Powder

| | | |
|---|---|---|
| Fe-based Acicular | 100.0 | parts by weight |
| Ferromagnetic Powder | | |
| (Fe/Co/Al/Y = 100/24/5/8 | | |
| (atomic ratio), Hc: 188 kA/m, σs: | | |
| 140 Am²/kg, BET specific surface area: | | |
| 50 m²/g, and average major axis | | |
| length: 0.10 μm) | | |

Binder

| | | |
|---|---|---|
| Vinyl Chloride Copolymer | 10.0 | parts by weight |
| (Product name: “MR110” made by | | |
| Zeon Corporation of Japan) | | |

Binder

| | | |
|---|---|---|
| Polyester Polyurethane | 6.0 | parts by weight |
| (Product name: “UR8300” made by | | |
| Toyobo Co., Ltd.) | | |

Dispersant

| | | |
|---|---|---|
| Phosphate surfactant | 3.0 | parts by weight |
| (Product name: “RE610” made by Toho | | |
| Chemical Industry Co., Ltd.) | | |

Abrasive

| | | |
|---|---|---|
| α-alumina | 10.0 | parts by weight |
| (Product name: “HIT60A” made by | | |
| Sumitomo Chemical Co. Ltd., average | | |
| particle diameter: :0.18 μm) | | |
| NV (solid concentration) = 30% | | |
| (percentage by mass)) | | |

Solvent Proportions

MEK/toluene/cyclohexanone = 4/4/2
(ratio by mass)

After the materials described above had been kneaded by a kneader, as a first-stage dispersing process, the mixture was dispersed using a horizontal pin mill filled with 0.8 mm zirconia beads to a fill ratio of 80% (a void ratio of 50 vol %).

After this, the mixture was diluted so that NV (solid concentration)=15% (percentage by mass) and the solvent proportions of MEK/toluene/cyclohexane=22.5/22.5/55 (ratio by mass), before a main (finishing) dispersing process was carried out. Next, after 10 parts by weight of a hardener (“Colonate L” made by Nippon Polyurethane Industry Co., Ltd.) had been added and mixed into the obtained coating composition, the composition was passed through a filter with an absolute filtering accuracy of 1.0 μm to fabricate the magnetic coating composition.

Non-Magnetic Layer Forming Process

The nonmagnetic coating composition is applied by being extruded from a nozzle onto one surface of a base film 4 that is 6.2 μm thick and made of PEN and then dried so that the thickness after the calendering process is 1.3 μm. After this, calendering is carried out using a calender that is a combination of a plastic roll and a metal roll, where the material is nipped four times, the processing temperature is 100° C., the linear pressure is 3500 N/cm, and the speed is 150 m/min. In addition, 4.0 Mrad of electron beam irradiation is applied with an acceleration voltage of 200 kV to form the non-magnetic layer 2.

Magnetic Layer Forming Process

The magnetic coating composition is applied from a nozzle onto the non-magnetic layer 2 formed as described above so that the thickness after processing is 0.1 μm, and then an orienting process and a drying process are carried out. After this, calendering is carried out using a calender that is a combination of plastic rolls and metal rolls, where the material is nipped four times, the processing temperature is 100° C., the linear pressure is 3500 N/cm, and the speed is 150 m/min to form the magnetic layer 3.

Back Coat Layer Forming Process

The back coat layer coating composition is applied by a nozzle onto the other surface of a base film 4 made of PEN so that the thickness is 0.5 μm, and then subjected to a drying process. After this, calendering is carried out using a calender that is a combination of a plastic roll and a metal roll, where the material is nipped four times, the processing temperature is 90° C., the linear pressure is 2100 N/cm, and the speed is 150 m/min to form the back coat layer 5.

The magnetic recording tape material obtained as described above is thermally hardened for 48 hours at 60° C. and then cut up into ½ inch (=12.650 mm) strips to fabricate samples of the magnetic tape as example 1.

### Examples 2 to 4, Comparative Examples 1, 2

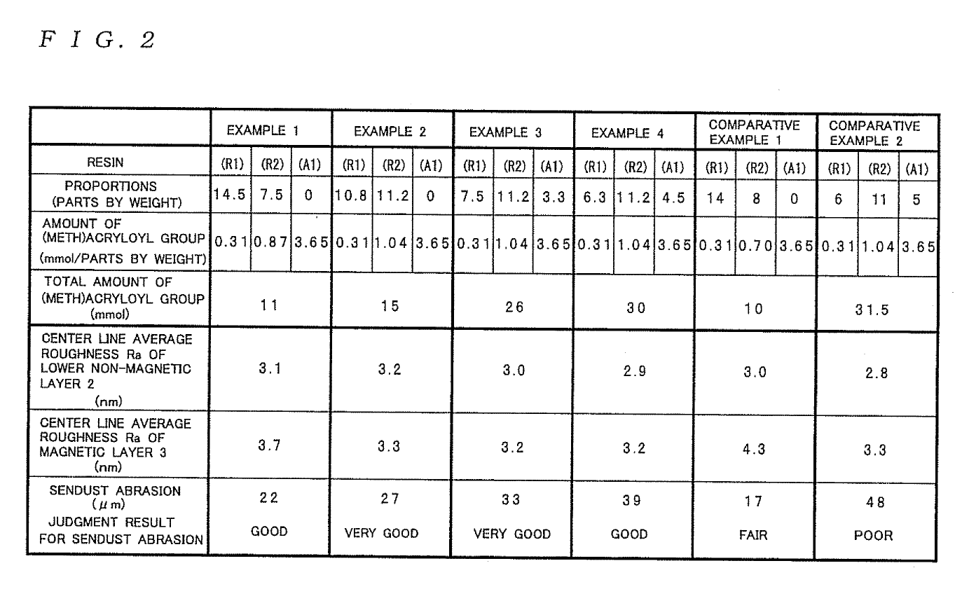

Various samples of magnetic tapes were fabricated as examples 2 to 4 and comparative examples 1, 2 in the same way as the example 1 described above by changing only the proportions of the electron beam-curable vinyl chloride resin (R1), the electron beam-curable polyurethane resin (R2), and acrylic monomer resin (A1) as shown in FIG. 2 when preparing the non-magnetic coating composition.

Evaluation of the Magnetic Tapes

The various magnetic tape samples were subjected to the evaluation tests described below.

Surface Roughness (Center Line Average Roughness: Ra)

By using a “TALYSTEP system” (made by Taylor Hobson Ltd.), the center line average roughness Ra of the surfaces of the non-magnetic layer 2 and the magnetic layer 3 is measured based on JIS B0601-1982. The measurement conditions were: filter 0.18 Hz to 9 Hz, a 0.1 μm×2.5 μm stylus, stylus pressure 2 mg, a measurement speed 0.03 mm/sec, and measurement length of 500 μm. Note that the measurement of the center line average roughness Ra of the surface of the non-magnetic layer 2 was carried out after the calendering process and electron beam irradiation but before the formation of the magnetic layer 3. The measurement of the center line average roughness Ra of the surface of the magnetic layer 3 was carried out after the final calendering process but before the thermosetting process.

Measurement of Sendust Abrasion

Measurement was carried out using a DLT-4000 drive in which a sendust bar (sendust bar made by NEC Tokin Corp., Fe—Si—Al alloy, product name: “Block”, material: SD-5) that is 50 mm long and has a 4.5 mm×4.5 mm square cross-sectional form was fixed by a fixing jig so that an edge of the sendust bar was perpendicular to the running direction of the magnetic tape 1. As the sendust bar, a bar with no abrasion at the edge and no chips or faults of a size of 1 μm or greater was used. The contact angle between the sendust bar and the magnetic tape 1 was set at 120.

In a constant temperature oven with a measurement environment of 23° C. and 45% RH, the magnetic tape 1 was run with a conditions given below so that the surface of the magnetic layer 3 of the magnetic tape 1 contact the sendust bar

Iterations: 50 returns (100 passes) of a 500 m length between the 21 m and 521 m marks of the magnetic tape 1

Running tension: 1N

Running Speed: 3.0 m/sec

After the magnetic tape 1 runs, measurement is carried out for ten points in the tape width direction of the abraded sendust bar, the average value is found, and such obtained average values are set as the sendust abrasion (μm) of the various tape samples. The sendust abrasion was judged as follows.

| | |
|---|---|
| Fair: | 15 μm < average value ≦ 20 μm |
| Good: | 20 μm < average value ≦ 25 μm |
| Very Good: | 25 μm < average value ≦ 35 μm |
| Good: | 35 μm < average value ≦ 45 μm |
| Poor: | 45 μm < average value |

The measurement results for the center line average roughness Ra of the surfaces of the non-magnetic layer 2 and the magnetic layer 3 and the sendust abrasion for the examples 1 to 4 and comparative examples 1 and 2 described above are shown together with the total amount of (meth)acryloyl group in the measurements graph in FIG. 2. From these measurement results, first, it was confirmed that the center line average roughness Ra of the surfaces of the non-magnetic layer 2 was in a preferable range of 2.0 nm to 4.0 nm, inclusive for the magnetic tape samples of the respective examples 1 to 4 and comparative examples 1 and 2. Next, it was confirmed that the center line average roughness Ra of the surfaces of the magnetic layer 3 was in a preferable range of 1.0 nm to 5.0 nm, inclusive for the magnetic tape samples of the respective examples 1 to 4 and the comparative examples 1 and 2, and in a more preferable range of 1.0 nm to 4.0 μm, inclusive for the magnetic tape samples of the respective examples 1 to 4 and the comparative example 2. Next, it was confirmed that the sendust abrasion was in a favorable range of 20 μm to 45 μm for the magnetic tape samples of the respective examples 1 to 4, and in an optimal range of 25 μm to 35 μm for the magnetic tape samples of the respective examples 2 and 3. On the other hand, although it was confirmed that the sendust abrasion was in a usable range of 15 μm to 20 μm for the magnetic tape samples of comparative example 1, the sendust abrasion for comparative example 2 was too large and therefore comparative example 2 cannot be used.

Accordingly, for a magnetic tape 1 including a non-magnetic layer 2 formed using a non-magnetic coating composition prepared so as to include (meth)acryloyl group in a range of 11 mmol to 30 mmol inclusive relative to 100 parts by weight of the non-magnetic powder (carbon black and non-carbon black non-magnetic inorganic powder), the non-magnetic layer 2 has favorable hardness, and therefore it is possible to keep the surface characteristics of the non-magnetic layer 2 after the calendering process favorable. It was confirmed that by doing so, it is possible to set the center line average roughness Ra of the surface of the magnetic layer 3 in a favorable range. It was also confirmed that since it is possible to set the non-magnetic layer 2 with favorable hardness, the penetration into the non-magnetic layer 2 of the abrasive included in the magnetic layer 3 when the calendering process has been carried out on the magnetic layer 3 can be set optimally, the amount by which the abrasive protrudes from the magnetic layer 3 can be set optimally, and therefore abrasion of the magnetic head by the magnetic tape 1 (i.e., the cleaning performance of the magnetic tape 1) can be kept in a favorable state. In addition, for a magnetic tape 1 including a non-magnetic layer 2 formed using a non-magnetic coating composition prepared so as to include (meth)acryloyl group in a range of 15 mmol to 26 mmol inclusive relative to 100 parts by weight of the non-magnetic powder, it is possible to further optimize the hardness of the non-magnetic layer 2, and therefore it is possible to further optimize the penetration into the non-magnetic layer 2 of the abrasive included in the magnetic layer 3 when the calendering process has been carried out on the magnetic layer 3. It was also confirmed that since it is possible to further optimize the amount by which the abrasive protrudes from the magnetic layer 3, the abrasion of the magnetic head by the magnetic tape 1 (the cleaning performance of the magnetic tape 1) can be kept in a more favorable state.

What is claimed is:

1. A magnetic recording medium where at least a non-magnetic layer and a magnetic layer are formed in the mentioned order on one surface of a non-magnetic support,
wherein the non-magnetic layer is formed using a non-magnetic coating composition including a (meth)acryloyl group in a range of 11 mmol to 30 mmol, inclusive relative to 100 parts by weight of non-magnetic powder.

2. A magnetic recording medium according to claim 1, wherein the non-magnetic coating composition includes the (meth)acryloyl group in a range of 15 mmol to 26 mmol, inclusive.
